(19) United States
(12) Patent Application Publication
(10) Pub. No.: US 2006/0229995 A1
(43) Pub. Date: Oct. 12, 2006

(54) Report form generator for anonymous reporting system

(76) Inventor: Eugene F. Ferraro, Pine, CO (US)

Correspondence Address: BROWNSTEIN HYATT & FARBER, 410 SEVENTEENTH STREET, 22ND FLOOR, DENVER, CO, 80202, US

(21) Appl. No.: 11/358,728

(22) Filed: Feb. 21, 2006

Related U.S. Application Data
(63) Continuation-in-part of application No. 10/288,835, filed on Nov. 5, 2002.
(60) Provisional application No. 60/337,036, filed on Nov. 6, 2001.

(51) Int. Cl. G06Q 99/00; H04L 9/00; H04K 1/00

(52) U.S. Cl. 705/74

(57) ABSTRACT

An anonymous reporting system for use in reporting and following up on incidents, accidents, and the like. The system may be accessed via an Internet website. A reporting individual may select a type of incident to report. A report form specific to that type of incident will then be provided for the reporting individual to complete and submit. The particular report form that corresponds to a particular type of incident can be a template form defined by an administrator of the website or a form defined by a customer of the services supplied by the administrator.

This application claims priority as a continuation-in-part application from U.S. patent application Ser. No. 10/288,835, filed Nov. 5, 2002, which claims priority from U.S. Provisional Application No. 60/337,036, filed Nov. 6, 2001, the contents of each of which are incorporated herein by reference.

### TECHNICAL FIELD

The present invention relates generally to systems for handling and arranging information, and more particularly to information handling for receiving and categorizing anonymous reports in relationship to security and safety issues, and for methods of generating report forms in such applications.

### BACKGROUND

The reporting of “incidents” is often of great value in recognizing potential problems before the persons involved go further along the same paths, too often with tragic or unfortunate results. Early recognition of problem personalities or trends can provide opportunities for intervention and prevention of more serious activities. Incidents of all sorts occur frequently in social circumstances, such as in schools or the workplace, where stress can lead to escalation, and escalation can lead to violence. The problems relate to groups which include three of the largest segments of the population; children attending school from age five through eighteen, students attending secondary school and those employed. The latest U.S. census estimates that 73 million Americans are in school and 134 million are in the workplace. Those in charge of security and the well being of the persons in these situations often have a “need to know” about incidents which might seem minor, but can be the harbinger of events of greater consequence.

Difficulties occur in the handling of reports and in encouraging observers to make the incidents known to those in authority, however. These difficulties arise in areas of collating and correlating the incidents and in maintaining secrecy and the privacy of the persons involved, whether they are the perpetrators or the witnesses. There is frequently a fear factor involved among witnesses, as well as a general reluctance to get involved or to be seen as “snitch” or troublemaker. Overcoming obstacles to reporting incidents, and providing a structure for discreet and efficient handling of reports is accordingly a matter for concern.

A major concern in modern society deals with these incidents, especially in light of trends of violence in the workplace and educational institutions. Today, violence, including sexual assault and harassment, is so prevalent in the workplace that, in many organizations it has become an accepted fact of life.

The National Center for Victims of Crime reported 709 homicides in the workplace during 1998 and 13 million workers say they are concerned about the behavior of a coworker they think could become violent. Twenty-five percent of workers said their company offered training on workplace violence, sixty-five percent said theirs did not, and nine percent said they did not know if work had offered any training or help. Nine percent of workers reported an assault or other violent act in their workplace in the past year, and eighteen percent reported a threat or verbal intimidation, three out of every four say they are getting no guidance on how to prevent violence or how to recognize the dangers of violence [National Center for Victims of Crime, 1999].

These astounding figures suggest that more than 12 million acts of violence and 24 million threats or verbal intimidations occur each year [U.S. Department of Education and Justice, 1998]. Only 25 percent of the companies surveyed have begun, in some way, to address violence at work [Business Controls, Inc., What Every Employer Should Know About Workplace Violence, 2000]. While many companies have begun to recognize the need to address the potential for violence, it is evident that they are looking for a starting point. Anonymous employee “hotlines” have been established to meet this need. Many of the hotlines were established without thought as to who might use them and how they would be used.

In addition, most telephone hotlines and other incident reporting systems utilize a standard incident report form. As can be appreciated, the standard form may have a variety of fields that ask for information relevant to each of the different types of reports that might be made. It can also be appreciated that certain portions of this requested information is completely irrelevant to or inapplicable to certain types of incident reports. Asking a reporting individual to supply some of this irrelevant and inapplicable information can, at worst, frustrate the individual enough to not complete and submit the form or, at best, annoy the individual.

In 2002, the U.S. Congress enacted the Sarbanes-Oxley Act which closely regulates corporate governance and financial practice. In particular, increased requirements were placed on corporations to collect and report information that may be relevant to shareholders.

In light of the great need for finding ways to obtain and correlate information on preliminary incidents, as a tool for preventing violence and harassment, and the general lack of success in overcoming these by mere security presence alone, there exists an opportunity to refine and improve the methods. In particular, methods for encouraging greater participation in reporting, creating a greater degree of witness confidence and safety, and collecting appropriate information relevant to the incident to be reported are needed.

### SUMMARY

Accordingly, it is an object of the present invention to provide an anonymous incident reporting system that collects data that is relevant to the type of incident being reported. Another objective is to provide for the collection of data that is relevant to the type of incident being reported and which provides for the ability of entities to provide customized report forms for reporting individuals to use in making reports relative to that entity.

The invention relates to an internet-based system for use by a reporting individual. The system includes a web server that provides a reporting individual the opportunity to make a report relative to one of a plurality of entities, the reporting individual having the option to remain anonymous in the report. The server further allows the reporting individual to select a type of report that the individual wishes to make and, based on that selection, a corresponding report form is generated for that type of report to be made. The corresponding form is different for different types of reports to be made.

The system may be separately configurable for each of a plurality of entities, wherein every reporting individual is associated with an entity, wherein the corresponding form for a given type of report for one entity is different from the corresponding form for the same given type of report for at least one other entity. The reporting individual can enter data in defined fields on the corresponding report form that is generated.

The individual may have the choice of different levels of anonymity. The individual may have the choice of three different levels of anonymity. One of the choices the individual may have is complete anonymity. One of the choices the individual may have is anonymity toward the entity but not toward administrators of the system. One of the choices the individual may have is no anonymity.

The reporting individual may make the selection of the type of report that the individual wishes to make by selecting one of a plurality of types of reports listed in a pull-down menu. The corresponding report form for a given type of report may differ from a corresponding report form for another type of report by the defined fields in the report forms. The differences between the defined fields on different report forms may relate to different requested information.

The invention also relates to a method for collecting incident reports from reporting individuals about a group of entities via the internet. The method includes providing a website for reporting individuals to visit; allowing the reporting individual to identify the entity; allowing the reporting individual to select a type of report to be submitted; providing a report form that corresponds to that type of report, based on the selection of report type; allowing the reporting individual to enter data into the report form; allowing the reporting individual to remain anonymous in the report; and allowing the reporting individual to submit the form.

Each entity may specify the report form corresponding to each report type that will be provided to reporting individuals who identify that entity. Each entity specifying the report form may include allowing each entity to provide a customized report form.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

FIG. 1 (including FIGS. 1A and 1B) is a schematic illustration showing the operation of the anonymous reporting system in a flow chart style.

FIG. 2 is a flow chart of the improved report form generation feature of the anonymous reporting system.

FIG. 3 is an example of a report form that is tailored for a particular type of incident to be reported, namely Fraud.

FIG. 4 is an example of a report form that is tailored for a particular type of incident to be reported, namely Sexual Harassment.

FIG. 5 is an example of a report form that is tailored for a particular type of incident to be reported, namely Theft.

### DETAILED DESCRIPTION

The present invention is an anonymous incident reporting and communications system 10 for schools, businesses, public institutions, and governmental agencies. The system 10 involves services coordinated by a system provider 12 and utilized by a variety of institutional participants 14 and individual constituent users 16. The system 10 allows participants 16 to anonymously and easily report threats of violence, harassment, sexual misconduct, discrimination, dishonesty or other concerns in a timely and safe manner via telephone 18 or the Internet 20. Its services enable participants 14 to anonymously generate confidential reports and instantly transmit them to a pre-designated recipient 22 in the subscriber organization or institution, and to anyone else of the participant's choosing. The interface 24 is simple, intuitive, and user-friendly. The experience is efficient, rewarding, and safe.

In addition to incident reporting, users (“User(s)”) 16 can also report workplace accidents, pass along suggestions and obtain safety information.

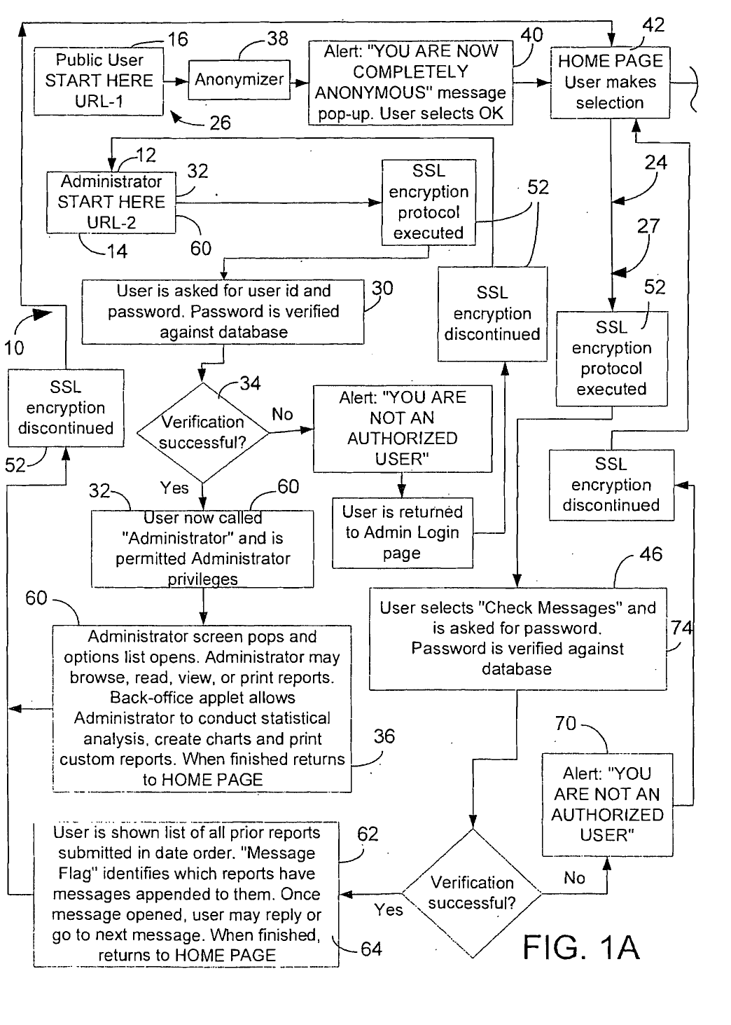

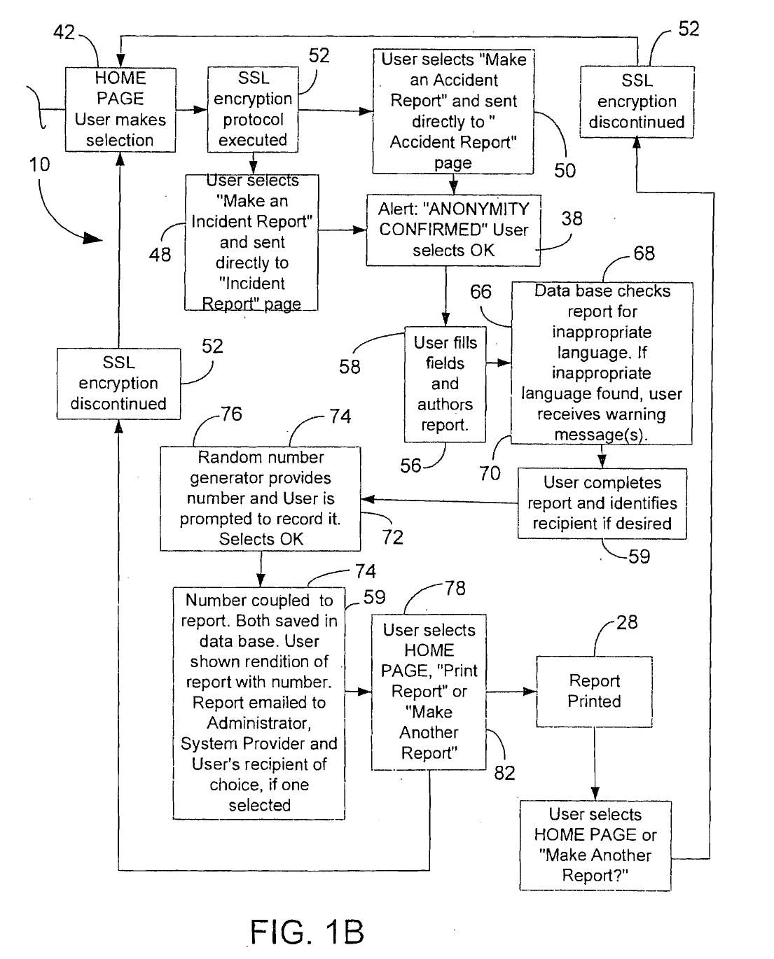

The general operation of the system 10 is shown in a flow chart manner in the illustration of FIG. 1 (shown as divided into FIGS. 1A and 1B for presentation purposes). This illustration shows the operation of the system 10 in response to an access request 26 by any user 14. The access request may be direct, as in an online electronic access, or indirect, where a telephone report is provided and then, either concurrently or subsequently entered into the system 10 by personnel of the system provider 12. The interface 24 with the system 10, whether directly or delayed (as in the case of telephone communication), is through the website 27 which is provided by the System Provider 12. One or more websites 27 may be provided, with each being customized to the requirements of the particular institutional participant(s) 14.

As is illustrated in the flow chart, upon submission of a report 28 (regardless of type), Users 16 are immediately issued a confidential access number 30. The access number 30 allows the User 16 to anonymously follow up on his or her report 28 at a later date, and provide additional information or assist further if necessary. Services, whether accessed via telephone 18 or the Internet 20, are available to Users 16 at any time of day or night, seven days a week.

The most complex aspect of the service is the feature-rich Internet and website component 27. FIG. 1 illustrates in some detail how the user interfaces 24 with the website 27 through the Internet 20 and how the information provided is managed and disseminated. The process is engineered to allow anonymous and encrypted communications between the User 16 and a pre-assigned administrator (“the Administrator”) 32. The Administrator 32 will typically be associated with the system provider 12 and may administer the service for a variety of separately maintained services for institutional participants 14. The User 16 is permitted to create and print reports 28, as well as respond to inquiries 34 posted by the Administrator 32. The Administrator 32 may browse, read, view, and print those reports 28. A back-office application 36 allows the Administrator 32 to use reports 28 to conduct statistical analysis, create charts, and print custom reports.

The system 10 of the present invention involves numerous unique features, one of the most significant of which is the optional “anonymizer” 38 feature. The anonymizer 38 operates as follows: upon entering the site 27, the User 16 is immediately anonymized. All identifying information is rendered unintelligible and is immediately purged when the User leaves the site. The pop-up message “YOU ARE NOW COMPLETELY ANONYMOUS” 40 appears as soon as the User 16 accesses a HOME PAGE 42 opening, which is the entry to the website 27 and the system 10. The User 16 clicks it away by clicking “OK”. The User 16 will remain anonymous until he leaves the site. Upon anonymization, a small icon 44 (shield with the letter “A” in it) will appear in the browser tool tray of the User 16. The icon 44 will remain visible as long as the anonymization is in effect.

From the HOME PAGE 42, the User 16 makes a choice by selecting “Check Messages” 46, “Make an Incident Report” 48 or “Make an Accident Report” 50. In each case, an SSL (Secure Socket Layer) encryption protocol 52 is executed. The User 16 will be alerted to such by a message window and the appearance of a small padlock icon 54 appearing in the tool tray of their browser. Double-clicking on this icon 54 will reveal the digital certificate assigned, confirming encryption. SSL encryption services will be provided for the site by a commerce vendor, such as Verisign.

Regardless of the nature of the report indicated, which will depend entirely on the situation, report data 56 of indefinite length may then be entered. The system 10 provides a word processor data entry screen 58 which allows the User 16 to enter and edit, in a report form 59, whatever sort of information is desired. The word processor screen 58 remains open until the User 16 has determined that the data entry is complete and has submitted it to the system 10. Any information or report provided by the User 16 while SSL is enabled will be encrypted until notified otherwise. When the User 16 leaves a secured portion of the site, encryption will conclude and the padlock icon 54 will disappear from the toolbar.

Administrative rights will be granted to designated client participants (usually security personnel associated with the subscriber participants 14). These participants will be a part of the group called Administrators 32. Administrators 32 will be provided an “Access Code” and access number 30. Upon verification against a database, Administrators 32 may view reports created by their associated Users 16 (e.g. their employees or students).

Reports 28 created by Users 16 will be stored in a relational database (see below for how reports are created). Administrators 32 may browse, read, view, and print reports 28. The back-office application 36 allows them to conduct statistical analysis, create charts and print custom reports for their own purposes.

A Web Master 60, who will typically be a person associated with and controlled by the system provider 12 will have rights to perform any Administrator function, assign access numbers and access codes, as well as post messages in response to User reports. Only the Web Master 60, a designated Administrator 32, and the report's author (the specific User 16 who generated the particular report 28) will be permitted to view prior reports and Web Master postings.

A “message flag” 62 will identify reports 28 within the database with messages 64 posted by the Web Master 60. The object is to allow the User 16 and the Web Master 60 to have electronic dialogue (much like email) where both remain anonymous. When the User 16 next logs on they will be able to select the “Check Messages” 46 on the HOME PAGE 42 and will have an opportunity to review and reply to the messages 64 from the Web Master 60. An optional feature, depending on the desires of the subscriber participant 14, relates to a method for filtering “offensive language” as defined for the particular purpose. In this feature, known as an offensive language filter 66, a spell check module 68 will detect offensive words if used by the User 16 while completing the form and filling in fields in the report form 59. The User 16 will be warned of such and the offending language will be X'ed out, but not deleted. A warning message 70 will pop up, warning the User 16 not to use offensive language again. A database will be used to spell-check and identify offensive language for this purpose. It is recognized that this feature will need to permit the use of such language in quoting the details of incidents and the like, and will be flexible to allow limited usage of the forbidden terms, in the proper context.

At the end of the form 59, the User 16 is offered the opportunity to email the report to anyone of his choice. Regardless of the choice, the report 28 will also be distributed to predetermined designated recipients identified by the client/subscriber 14.

The User 16 is then prompted to press a “Get Access Number” button 72 in order to obtain a user and report specific access number 74. In doing so, a random number generating method 76 produces a unique nine-digit access number which becomes the User access number 74 associated with the report 28. The User 16 is instructed to manually record this. Simultaneously, the user access number 74 is coupled to the report 28 and saved in a database. The User 16 is prompted to submit the report 28 and in doing so, is shown a non-editable rendition of the report and reminded again of his/her user access number 74. The User 16 is then provided the option to “Submit Report” or “Redo” 78. Selection of “Redo” restarts the process.

Submission of the report 28 immediately results in the system 10 emailing the report to the Web Master 60 and any designated recipient 22 (selected system provider managers or report reviewers). The report 28 is also bounced against a “Fuzzy Database” 80 in an effort to identify the client Administrator or client-designated recipient. Because the website 27 is open and entry is not password protected, anyone with Internet access can enter the site and create/submit a report 28. As such, the User 16 cannot be provided pull-down lists to identify and select his/her employer or school because of confidentiality concerns. Additionally, any typographical error or misspelling on the part of the User 16 may make the identity of the corresponding client 14 impossible to determine electronically. The “Fuzzy Database” 80 containing permutations of the names of subscriber clients 14 will be used to link the User's report 28 to the proper client 14. Once linkage is accomplished, the report 28 will be emailed to the pre-designated client recipient 22. If no match is found, the report 28 is forwarded to a default Administrator 32 who determines future handling.

The user access number 74 created in the process will allow the Web Master 60 to post messages 64 to a desired report 28. In turn, Users 16 may later return to the site and retrieve those messages 64 by identifying him/herself only with the user access number 74. Upon re-entry to the site 27, a User 16 retrieving messages may append an existing report 28 or create a new one. A new report 28 will generate a new user access number 74.

Upon leaving the site, the User 16 may optionally be offered the option of placing an “Auto-shortcut” 82 to the site 27 on his/her desktop and/or in his/her tool tray. Corporate subscriber clients 14 will be provided a small shortcut application 84 which they can install or download onto all corporate workstations, which will place the “Auto-shortcut” 82 on the desktop and/or in the tool tray.

In addition to the above-mentioned examples, various other modifications and alterations of the anonymous incident reporting system 10 may be made without departing from the invention. Accordingly, the above disclosure is not to be considered as limiting and the appended claims are to be interpreted as encompassing the entire spirit and scope of the invention.

As described above, the present invention is utilized in the context of safety, security and personnel management applications, particularly in schools and the workplace. The system 10 is adapted to be accessible to any interested party with access to provided telephone 18 numbers or websites 27. Potential subscriber clients 14 will typically be institutions, either academic or corporate, with concerns about controlling incidents which may presage more serious future conduct.

The operation of the system 10 is as shown in the drawing and described above. For the above, and other, reasons, it is expected that the anonymous reporting system 10 of the present invention will have widespread industrial applicability. Therefore, it is expected that the commercial utility of the present invention will be extensive and long lasting.

Further, a recent enhancement to the above-described anonymous reporting system features the ability to provide report forms that are tailored to the type of incident to be reported. Such a system is described in further detail below.

For example, an individual wishing to make a report may access a website such as www.mysafeworkplace.com where they can make a selection to indicate they wish to make a report. After making this selection, they may be redirected to a secure site where they are asked to enter the name of the organization or entity for which a report is to be made. For example, the individual may be asked to enter the first three letters of the organization's name. If the three entered letters are recognized, then a generic report form relative to that company appears for the reporting individual to complete.

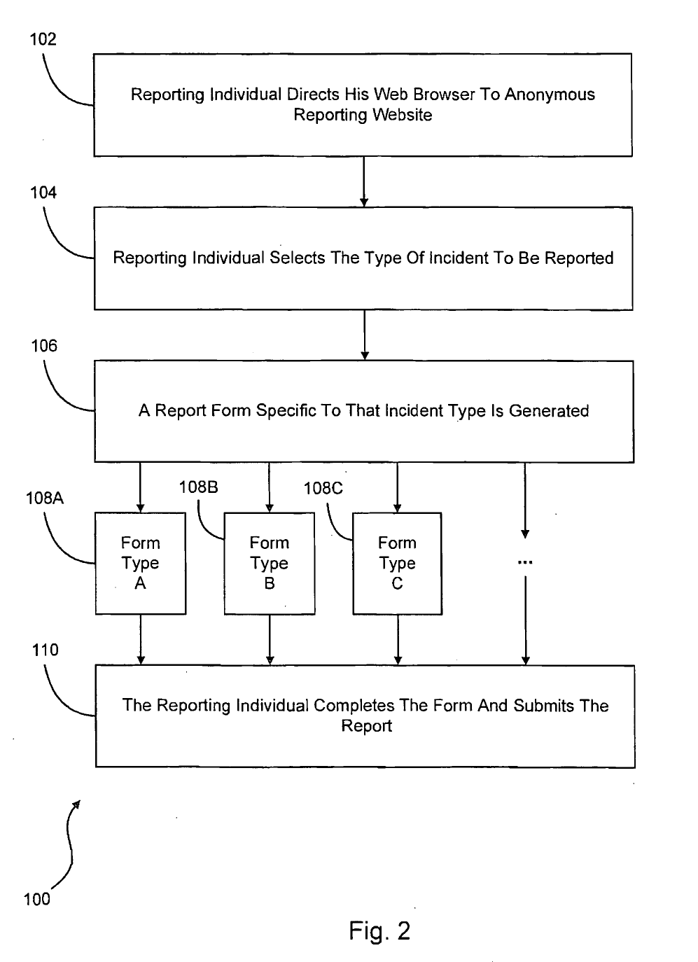

The improved report form generator of the anonymous reporting system, however, differs at this point. Instead, as shown in flowchart 100 in FIG. 2, after accessing the website (102) the individual is asked what type of report they wish to submit. After selecting a type of report (104), the screen automatically changes to provide a report form (106) that is tailored to the type of incident to be reported. For example, an incident entitled “Accounting Error” would result in a different report to be generated than would selection of an incident such as “Corporate Scandal”, “Harassment”, “Theft”, or “Workplace Violence.” The reporting individual then completes and submits the form (108).

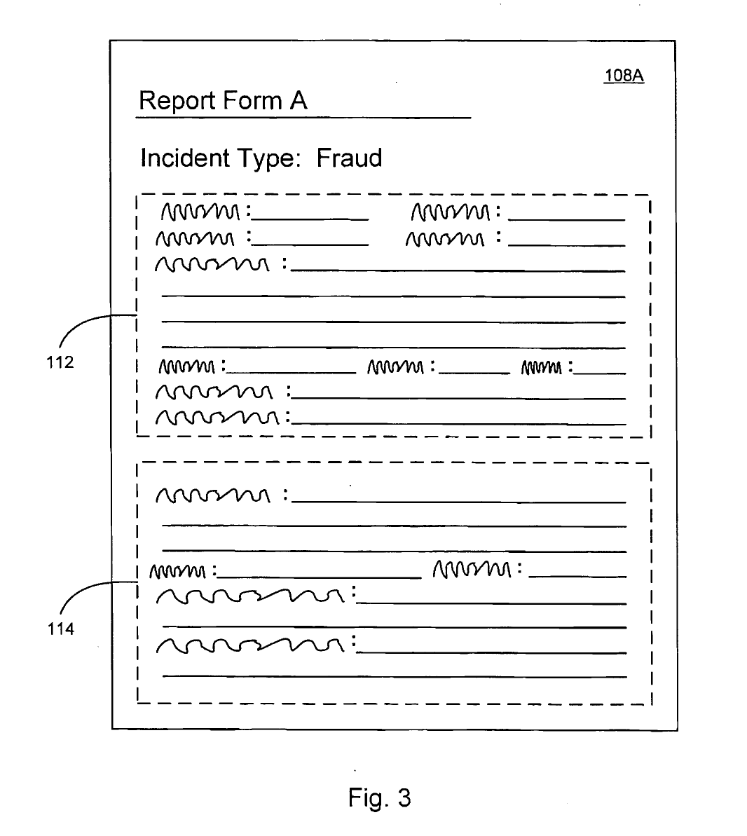

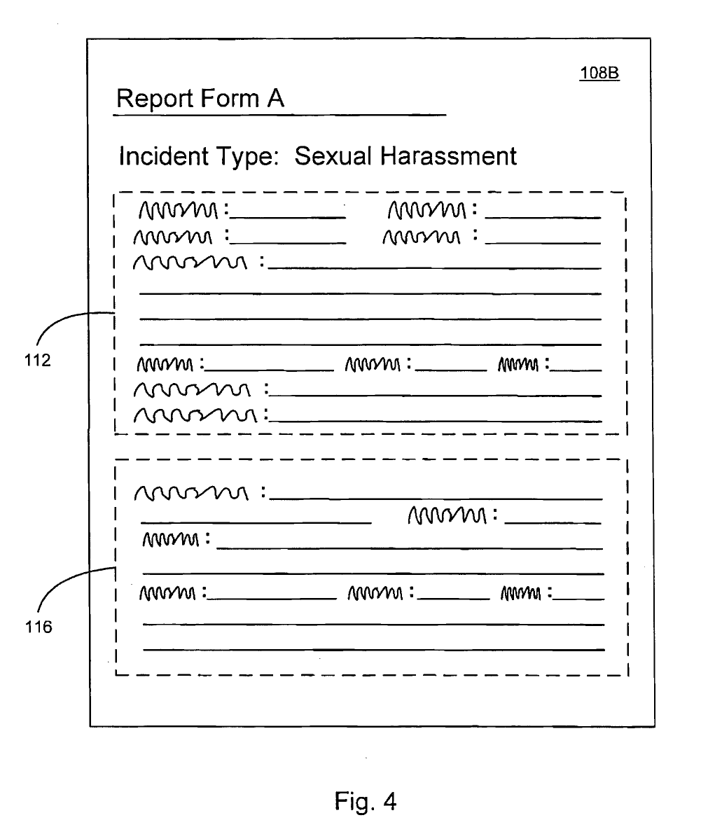

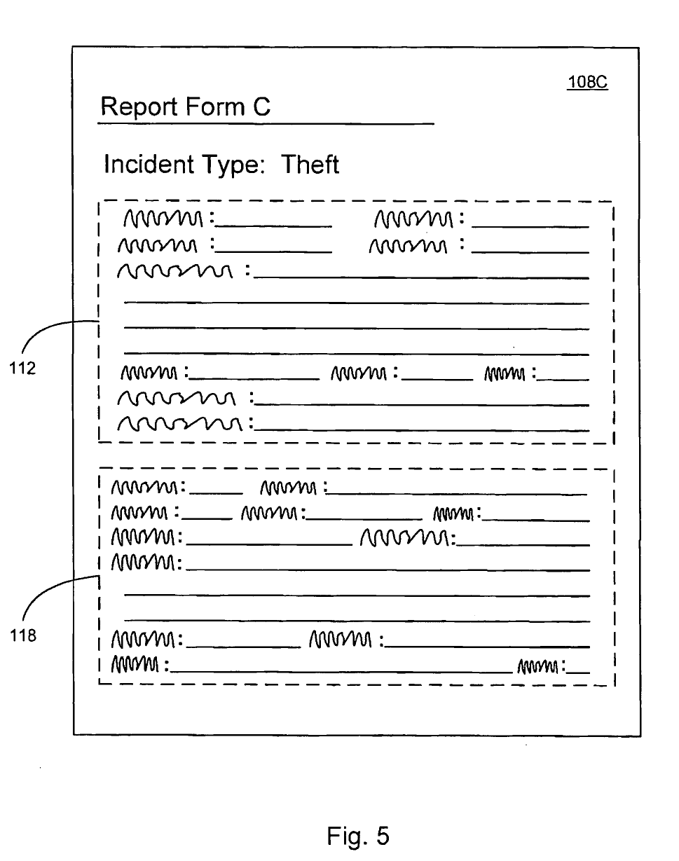

Examples of some report forms that are specific to various types of incidents to be reported are shown in FIGS. 3, 4, and 5. In FIG. 3, the form 108A relates to an Incident Type of Fraud. The form 108A includes a section 112 of questions that are common to each of the types of forms. The form also includes a section 114 of questions that are unique to each of the types of forms. Similarly, FIG. 4 shows a form 108B that relates to an Incident Type of Sexual Harassment. The form 108B includes a section 112 of questions that are common to each of the types of forms. The form also includes a section 116 of questions that are unique to that type of form. Similarly, FIG. 4 shows a form 108C that relates to an Incident Type of Theft. The form 108C includes a section 112 of questions that are common to each of the types of forms. The form also includes a section 118 of questions that are unique to that type of form.

It can be appreciated that the anonymous reporting system may be administered by one entity, such as the entity that maintains and administers the www.mysafeworkplace.com website. Various customers may engage this administrator/entity to list those customers as organizations at the entity's anonymous reporting system website so that reporting individuals can make reports about those customers. These customers may be referred to herein as users. The individuals who visit the website and make reports are referred to herein as reporting individuals. Thus, it can be appreciated that each of the administrator, the users, and the reporting individuals have different rights and abilities to modify the website and enter data there.

It is possible for the user to arrange either for an administrator-defined template report form to be provided to the reporting individual for a given type of incident to be reported, or to provide a user-defined report form to the reporting individual for a given type of incident to be reported. The administrator-defined template report forms are stored in a global repository by the administrator along with matching incident types. These template report forms and incident types can be transferred by a user to a custom repository specifically assigned to that user. As may be desired, these template report forms and incident types can be modified by the user before they are stored in the custom repository. Alternatively or additionally, the user can create completely new and original forms and store them in their custom repository. In preparing such a user-defined form, the user can determine what type of fields are going to be in the forms and what type of input fields are associated with certain form elements. For example, answer fields may be any of various general HTML form entities such as text lines, text field, yes/no field, combo box, list box, and so forth.

For example, the users may have access to a Forms Setup Wizard to allow them to create their own forms. One exemplary process for setting up forms may provide that certain fields are provided on all forms and other portions of the form are customizable. For example, the following fields may be available on all forms: incident date/time, organization name, location, department, incident type, recipients of the report, and description of the incident. Customizable portions of the form may include any of various custom questions the user wishes the reporting individual to complete relevant to a particular type of incident to be reported. Entering the Forms Setup Wizard may take the user to a main menu screen where they can select a link to continue with Wizard, select a link to an Incident Type List screen, or select a link to an Incident Form List screen. If the user continues with the Wizard, they may be provided with a list of options that takes them to different places in the Wizard program. For example, Option 1 may take the user to the Incident Type List screen, Option 2 may take them to the Create New Form 1 screen, Option 3 may take them to the Wizard Step 2 screen, Option 4 may take them to the Wizard Step 5 screen, Option 5 may take them to the Wizard Step 7 screen, and Option 6 may take them to the Wizard Step 8 screen.

If they select the Wizard Step 2 screen, the user would be permitted to specify an incident form name with a description. After this is done, they will be taken to the Wizard Step 3 screen at which point they will be permitted to create the individual fields for the form named in the previous step. The user can create unlimited fields for the form they wish to use for the specified type of incident. In creating these individual fields, the user may complete fields such as question/caption (to provide the text that will be displayed on the form as the caption or question), field type (such as text line, text area, yes/no, combo box, etc.), an indication as to whether a particular field is required, default text that may be provided, field width, minimum length, maximum length, row, and column. The above fields are for text fields and text areas. For yes/no boxes, the fields may include the default value and the type of yes/no box, such as a radio button, on/off, and so forth. If the field type is a combo box, then fields may include a definition of the values for the combo box starting with the default value and followed by the options. Fields may also include the type of combo box or list box, which may include drop down lists that provide only one selection or list boxes in which the user can select multiple options by pressing the control button.

Once this Wizard step is completed, the user will be taken to Wizard Step 4 where the user can select one or multiple types that will be associated with the form they have just created. They will then be taken to Wizard Step 5 where a new incident type can be created. Next, the user will be taken to Wizard Step 6 where they can select the incident form that will be used for the incident type created in the previous step. The incident form list contains only the incident forms that that user has in its own repository. It does not show global incident forms, such as those prepared by other users. The user is then taken to Wizard Step 7 where they can assign an existing incident form to an existing type in their repository.

Alternatively, if upon entering the Setup Wizard the user chooses the link to the Incident Type List screen, they would see a list of incident types and descriptions associated with the incident type. This list will be empty unless and until the user has created their own templates or chooses to select from the global template list. At this screen the user can select template report forms from the global template list and store them in their own repository. The user is also given the opportunity to create new forms much in the manner of Wizard Steps 2 and 3, described previously. The user can also access a list of incident forms that provide an overview as to what incident forms are in the organization's repository and what incident type they are assigned to.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. An internet-based system for use by a reporting individual, comprising:
a web server that provides a reporting individual the opportunity to make a report relative to one of a plurality of entities, the reporting individual having the option to remain anonymous in the report;
wherein the server further allows the reporting individual to select a type of report that the individual wishes to make and, based on that selection, a corresponding report form is generated for that type of report to be made;
wherein the corresponding form is different for different types of reports to be made.

2. A system as defined in claim 1, wherein the system is separately configurable for each of a plurality of entities, wherein every reporting individual is associated with an entity, wherein the corresponding form for a given type of report for one entity is different from the corresponding form for the same given type of report for at least one other entity.

3. A system as defined in claim 1, wherein the reporting individual can enter data in defined fields on the corresponding report form that is generated.

4. A system as defined in claim 1, wherein the individual has the choice of different levels of anonymity.

5. A system as defined in claim 1, wherein the individual has the choice of three 2 different levels of anonymity.

6. A system as defined in claim 4, wherein one of the choices the individual has is complete anonymity.

7. A system as defined in claim 4, wherein one of the choices the individual has is anonymity toward the entity but not toward administrators of the system.

8. A system as defined in claim 4, wherein one of the choices the individual has is no anonymity.

9. A system as defined in claim 1, wherein the reporting individual makes the selection of the type of report that the individual wishes to make by selecting one of a plurality of types of reports listed in a pull-down menu.

10. A system as defined in claim 1, wherein the corresponding report form for a given type of report differs from a corresponding report form for another type of report by the defined fields in the report forms.

11. A system as defined in claim 10, wherein the differences between the defined fields on different report forms relates to different requested information.

12. A method for collecting incident reports from reporting individuals about a group of entities via the internet, the method comprising:
providing a website for reporting individuals to visit;
allowing the reporting individual to identify the entity;
allowing the reporting individual to select a type of report to be submitted;
based on the selection of report type, providing a report form that corresponds to that type of report;
allowing the reporting individual to enter data into the report form;
allowing the reporting individual to remain anonymous in the report; and
allowing the reporting individual to submit the form.

13. A method as defined in claim 12, wherein each entity can specify the report form corresponding to each report type that will be provided to reporting individuals who identify that entity.

14. A method as defined in claim 13, wherein each entity specifying the report form includes allowing each entity to provide a customized report form.
